(19) United States
(12) Patent Application Publication
(10) Pub. No.: US 2023/0173602 A1
(43) Pub. Date: Jun. 8, 2023

(54) FEEDING DEVICE FOR FEEDING WELDING FILLER ELEMENTS FOR A DEPOSITION WELDING PROCESS AND METHOD

(71) Applicant: FRAUNHOFER-GESELLSCHAFT ZUR FÖRDERUNG DER ANGEWANDTEN FORSCHUNG E.V., München (DE)

(72) Inventors: Stefan GRÄFE, Grevenbroich (DE); Martin SCHULZ, Hamburg (DE)

(21) Appl. No.: 17/925,172

(22) PCT Filed: May 10, 2021
(86) PCT No.: PCT/DE2021/100428

§ 371 Date: Nov. 14, 2022

(30) Foreign Application Priority Data
May 13, 2020 (DE) 10 2020 113 012.0

(51) Int. Cl. B23K 9/133; B23K 26/70

(52) U.S. Cl. CPC B23K 9/133; B23K 26/702

(57) ABSTRACT

The invention relates to a feeding device (1) for feeding welding filler elements (310) for deposition welding processes, a positioning sleeve (300, 302) for a feeding device (1), a processing unit and a method for deposition welding. In particular, the invention relates to a feeding device (1) for feeding welding filler elements (310), in particular a wire-shaped and/or rod-shaped welding filler element (310), for a deposition welding processes, comprising a receiving unit (100) for receiving at least one welding filler element (310), a guide unit (200), which is arranged and designed to feed the welding filler element (310) to a deposition welding processes, the receiving unit (100) and the guide unit (200) being arranged and designed such that the welding filler element (310) is provided discontinuously to the guide unit (200).

The invention relates to a feeding device for feeding welding filler elements for a deposition welding process, a positioning sleeve for a feeding device, a processing unit, and a method for deposition welding.

In industry, deposition welding processes are used for a wide variety of applications. In particular, laser deposition welding is an efficient and effective process for repairing tools and turbine components. For these applications, wire-based laser deposition welding has become particularly popular because of its low heat-affected zone and good controllability. In addition, laser deposition welding, in particular wire-based laser deposition welding, can be used for coating workpieces, also known as laser cladding, and as an additive manufacturing process. In wire-based laser deposition welding, wire as an additive material has the advantage over other additive materials, such as powders, in that wire, in particular compared to powder, is non-hazardous, poses no health risks, is less expensive and is more efficient.

In the past, process optimizations have focused in particular on enabling a smaller focus diameter and decreasing power in order to reduce the thermal load on the workpiece. This has led to a reduction in the size of the melt pool into which the wire is introduced in wire-based laser deposition welding. Usually, the wire is wound on spools and, starting from the spool, is conveyed over various feeders, usually with changes of direction, to the molten pool.

In the prior art, process interruptions occur regularly. In addition, other process disturbances occur and the feeders for the wire are ground out. Grinding out the feeders often creates clearance, which has further negative effects on the process. The wire diameter is limited by the fact that the wire is to be conveyed to the deposition welding processes by means of the feeders, so that the wire must not be too rigid.

It is therefore an object of the invention to provide a feeding device for feeding welding filler elements for a deposition welding processes, a positioning sleeve for a feeding device, a processing unit, and a method for deposition welding, which reduce or eliminate one or more of said disadvantages. In particular, it is an object of the invention to provide a solution that enables improved process stability of a deposition welding processes, in particular a laser deposition welding process. At least, it is an object of the invention to provide a solution that offers an alternative to existing systems and processes.

According to a first aspect, said object is solved by a feeding device for feeding welding filler elements, in particular a wire-shaped and/or rod-shaped welding filler element, for a deposition welding process, in particular a laser deposition welding process, comprising a receiving unit for receiving at least one welding filler element, in particular a wire-shaped and/or rod-shaped and/or straight welding filler element, a guide unit which is arranged and designed to feed the welding filler element to a deposition welding process, in particular a laser deposition welding process, the receiving unit and the guide unit being arranged and designed in such a way that the welding filler element is provided to the guide unit discontinuously.

The invention is based on the perception that the precise feeding of the wire required by downsized melting baths is usually prevented by wire curvature. This wire curvature is caused by the storage of the wire on the spool and the feed path from the spool to the melt bath. This path can be around 15 meters for a processing machine and usually includes deflections. Auxiliary motors are usually used to convey the wire to compensate for the friction in the wire core.

In addition, the invention is based on the perception that a change of material and/or a change of wire diameter is costly in the process known in the prior art. The wire used is removed and a wire of a different material and/or diameter must be fully threaded into the feed path. Furthermore, in the known process, it must be considered that, in particular when the wire diameter is changed, guide rollers, for example within the auxiliary motors or wire formers, usually have to be changed.

The curvature of the wire due to the storage on a spool can be corrected in the prior art by wire funnels. Conveying the wire around several deflections can again cause curvature of the wire. To compensate for this, additional wire funnels can be used, keeping in mind that each wire funnel creates significant resistance in wire conveying, creating further causes for conveying inaccuracies.

The inventors have further found that forces generated by the rapid retraction motion of removing the wire from the melt pool are another cause of wire curvature. This occurs particularly when wire funnels are used. In the prior art, the wire is always pulled through the wire hopper by the wire feed motors. Pushing through the wire hopper is usually not possible and causes kinking of the wire. The kinks can occur especially during the backward movement, i.e. the retraction movement, of the wire. The wire bend cause the wire to wobble around the weld spot, in particular the laser spot, so that precise feeding of the wire to the weld pool is not possible.

By storing the at least one filler metal, in particular a plurality of filler metals, in the receiving unit, it is also possible to use wire-shaped and/or rod-shaped, in particular straight, filler metals. The use of straight, in particular previously straightened, welding filler elements was essentially not possible in the prior art because their feeding was not possible with the required accuracy and/or efficiency. In the prior art, only welding rods used, for example, for manual welding (TIG) are known, which can be designed, for example, as directional wire rods approximately 1 meter long. The length as well as the diameter can vary. The welding rods are not supported in a sleeve or the like. The welding rods may have a sheath, but the sheath is not such as to permit relative movement. Replacing the coil with the receiving unit for receiving wire-shaped and/or rod-shaped welding filler elements enables the welding filler elements to be fed to the weld pool with a precise geometry. The feeding by means of the feeding device is independent of the material and/or the diameter of the welding filler element. Continuous feeding is thus replaced by discontinuous feeding. Hereby, a change of the wire diameter and/or the wire material can be carried out essentially without set-up processes. Furthermore, the efficiency of the deposition welding process can be increased, since different wire diameters and/or wire materials can be applied one after the other in any desired manner without the need for costly set-up processes. This significantly increases the design freedom of the process developer.

In the following, the ends or sides of the components of the feed device that face the molten pool in the intended operation are referred to as distal ends, and the ends or sides of the components of the feed device that face away from the molten pool in the intended operation are referred to as proximal ends.

The welding filler element is preferably straight. Straight means in particular substantially not bent. It may be preferred that the welding filler element used has a round, an oval, a triangular, a square and/or a polygonal cross-section. In particular, the welding filler element is made of or comprises a welding filler material. The welding filler element is preferably straightened, cleaned and/or tested.

The welding filler element may be made of or comprise steel. In addition, the welding filler element may comprise or include nickel-based alloys, titanium-based alloys and/or cobalt-based alloys, aluminum, magnesium and/or copper alloys, or one, two or more of these materials. A dimension extending orthogonally to a longitudinal axis of the welding filler element, in particular a diameter, is preferably greater than 0.4 mm, in particular greater than 0.5 mm. Furthermore, it is preferred that this dimension is between 0.5 mm and 5 mm, in particular 3.5 mm, preferably 1.2 mm. The welding filler element can also be designed as a cored wire having a sheath enclosing a powder. The sheath and/or the powder may comprise or consist of one or more of the materials mentioned in the foregoing.

The receiving unit is configured to receive the at least one welding filler element. In particular, it is preferred that the receiving unit is configured to receive two or more or a plurality of welding filler elements. In particular, the receiving unit is designed for storing and/or magazining the welding filler elements. The receiving unit may have a chain feed, a belt feed and/or a loose feed via a rail in order to receive the welding filler elements and/or positioning sleeves described below and provide them to the guide unit. In particular, it may be preferred that the welding filler elements and/or positioning sleeves can be arranged one above the other in the guide unit in the vertical direction.

The guide unit is arranged and configured in such a way as to feed the welding filler element to the deposition welding processes. This means in particular that the guide unit can be used to move the welding filler element in such a way that a distal end of the welding filler element can be fed to a molten pool of the deposition welding processes. The guide unit preferably extends from a distal end to a proximal end. The distal end of the guide unit is in particular the end that faces the molten pool in the intended operation, and the proximal end is in particular the end that faces away from the molten pool in the intended operation.

The guide unit can, for example, have a guide channel within which the filler metal can be moved from an area adjacent to the proximal end or from a central area toward the distal end. In particular, it is preferred that the receiving unit is arranged on the guide unit such that the discontinuous supply of the welding filler element from the receiving unit to the guide unit takes place between the distal end and the proximal end of the guide unit.

A preferred embodiment of the feeding device is characterized in that the receiving unit is configured to receive at least one positioning sleeve, wherein the positioning sleeve is configured to be coupled to the welding filler element. Furthermore, it is preferred that the receiving unit and the guide unit are arranged and designed such that the positioning sleeve is provided discontinuously to the guide unit and the guide unit is arranged and designed to feed the filler metal to the deposition welding processes by means of the positioning sleeve.

A further preferred embodiment of the feeding device is characterized in that it comprises at least one positioning sleeve, wherein the at least one welding filler element is coupled to the positioning sleeve and the positioning sleeve can be received in the receiving unit, wherein the receiving unit and the guide unit are arranged and configured such that the positioning sleeve is discontinuously provided to the guide unit, and wherein preferably the positioning sleeve has a sleeve cavity for arranging and/or passing through the welding filler element. The sleeve cavity may, for example, have a passage axis extending from a distal sleeve end towards a proximal sleeve end.

Preferably, the positioning sleeve has an annular cross-section. In particular, it is preferred that the positioning sleeve has a tubular geometry, and further preferably a portion adjacent the distal end of the positioning sleeve is tapered. It is preferred that the section adjacent the distal end is cone-shaped, wherein in particular the geometry is adapted to process use angles. The cone-shaped section preferably extends in the direction of the longitudinal axis of the positioning sleeve with a cone extension of between 5 mm and 50 mm, in particular from 10 mm to 15 mm.

The positioning sleeve may, for example, be made of copper, tungsten copper, tungsten carbide, steel, brass, ceramic, in particular Si3N4, plastic and/or a mineral material, or may comprise one, two or more of these materials. A coupling section preferably adjoins a proximal end of the positioning sleeve, which is arranged opposite the distal end and preferably comprises an annular groove and/or a collar. Furthermore, it is preferred that a sealing element and/or a sealing means is arranged on an end face and/or on a radial circumferential surface of the coupling section. A groove depth of the groove, in particular in the radial direction of the positioning sleeve, is preferably between 0.5 mm and 5 mm and/or greater than 1 mm.

The positioning sleeve preferably has an outer dimension, in particular an outer diameter, orthogonal to a longitudinal axis of the positioning sleeve, which is between 5 mm and 20 mm, in particular between 8 mm and 12 mm. The length of the positioning sleeve parallel to the longitudinal axis of the positioning sleeve can be, for example, between 50 mm and 200 mm, in particular between 80 mm and 120 mm. The positioning sleeve is preferably substantially rigid.

A further preferred embodiment of the feeding device is characterized in that the receiving unit is set up to receive two or more positioning sleeves, each with a welding filler element, and preferably the two or more positioning sleeves can be arranged circumferentially, in particular in a first direction, next to one another in the receiving unit. Furthermore, it may be preferred that the two or more positioning sleeves are arrangeable circumferentially side by side in a second direction aligned substantially orthogonally to the first direction. This increases the capacity of the receiving unit and allows a large number of positioning sleeves with welding filler elements to be accommodated.

In a further preferred embodiment, the receiving unit is tubular, in particular such that positioning sleeves can be arranged end to end. Two or more positioning sleeves can be arranged one behind the other in the tubular receiving unit, in particular such that a distal end of a rear positioning sleeve faces a proximal end of a front positioning sleeve. It is further preferred that the receiving unit, in particular the tubular receiving unit, is coupled to a hose element for feeding the positioning sleeves to the receiving unit. The tubular receiving unit may be completely or partially tubular.

In a further preferred embodiment of the feed device, it is provided that the guide unit has a positioning section which is designed to position the positioning sleeve and/or the filler metal such that a distal end of the filler metal can be fed to a melt pool. The positioning section preferably adjoins a distal end of the guide unit.

It is further preferred that the positioning section has a guide channel that has an inner diameter corresponding to the outer diameter of the welding filler element and/or the positioning sleeve. Corresponding means in particular that the welding filler element and/or the positioning sleeve can be arranged inside the guide channel and/or forms or form a clearance fit with the guide channel.

According to a further preferred embodiment of the feeding device, it is provided that the latter comprises a movement unit which is set up to move the welding filler element and/or the positioning sleeve from a coupling region, in which the welding filler element and/or the positioning sleeve passes from the receiving unit to the guide unit, to a working region, in which the welding filler element is positioned such that it can be used for deposition welding processes. By means of such a movement unit, an automated operation of the feeding device can be made possible, namely that the positioning sleeves and/or welding filler elements automatically pass from the receiving unit to the guide unit and are moved from there by means of the movement unit to the working area for use for a deposition welding processes.

The receiving unit preferably has a transfer opening on a side facing the guide unit, which is arranged and designed so that welding filler elements and/or positioning sleeves can be transferred to the guide unit.

In a further preferred embodiment of the feed device, it is provided that the movement unit has a piston and the piston can be coupled to a proximal end of the welding filler element and/or the positioning sleeve. The proximal end of the welding filler element and/or the positioning sleeve is in particular the end that faces away from the molten bath during intended operation of the feed device.

The plunger preferably has, at its distal end facing the welding filler element and/or the positioning sleeve, a coupling element arranged and configured to couple the plunger to the welding filler element and/or the positioning sleeve. For example, the coupling element may be designed as a clamp that engages the groove of the positioning sleeve. In addition, the coupling element can also be magnetically coupled to the positioning sleeve, in that the coupling element and the positioning sleeve are designed to establish a magnetic connection. In addition, other material, force and/or positive coupling functions are also possible. For example, the piston can be operated electrically, hydraulically, or pneumatically. Preferably, the piston pushes the welding filler element and/or the positioning sleeve into the positioning section of the guide channel. The guide channel preferably tapers to facilitate positioning of the welding filler element and/or the positioning sleeve.

According to a further preferred embodiment of the feed device, it is provided that the guide unit is arranged to move the welding filler element relative to the positioning sleeve. Furthermore, it is preferred that a fluid, in particular a shielding gas, is supplied such that the welding filler element is moved out of the positioning sleeve, in particular continuously, preferably pressed. The guide unit, in particular the guide unit, preferably has a pressure relief valve which is set up to limit a pressure acting on the welding filler element and caused by the shielding gas. Furthermore, it is preferred that the guide unit is set up to exert a retraction force on the proximal end of the welding filler element, which is caused in particular by a negative pressure of the shielding gas.

In a further preferred embodiment of the feed device, it is provided that the movement unit has a fluid feed which is arranged and configured to feed a fluid to the proximal end of the welding filler element and/or the positioning sleeve in such a way that the welding filler element is moved out of the distal end of the guide unit and/or the positioning sleeve, in particular continuously, preferably pressed.

Due to its pressure, the fluid causes a force on the welding filler element and thus pushes it out of the guide unit and/or the positioning sleeve. Furthermore, it is preferred that the piston comprises a fluid channel, the first piston end of which is coupled to the fluid supply and the second piston end of which is coupled to the positioning sleeve, wherein the second piston end can be brought into fluidic contact with the welding filler element in order to exert the force on the welding filler element mentioned in the previous.

The fluid supply may in particular be a shielding gas supply. Preferably, the fluid is a shielding gas. The feed device may further comprise a feed unit for controlling the feed of the welding filler element out of the guide unit and/or out of the positioning sleeve. The feed unit may be designed, for example, as a brake that applies a braking force to the welding filler element.

In a further preferred embodiment of the feed device, it is provided that the feed device comprises a pushing unit that is arranged and configured to move the welding filler element out of the distal end of the guide unit and/or the positioning sleeve, in particular continuously, preferably to push it out. The pressing unit can be designed, for example, as a cylinder and/or a punch. Preferably, the pusher unit is coupled to a drive unit for driving the or a part of the pusher unit. The drive unit can be designed, for example, electrically, pneumatically and/or mechanically. In particular, the pusher unit is designed to be retractable, so that retraction and/or dispose of the positioning sleeve is possible.

In a further preferred embodiment of the feed device, it is provided that the latter comprises an ejection device for the positioning sleeve, which is set up to dispose of the positioning sleeve from the guide unit and/or the feed device. Preferably, the guide unit has an ejection opening for this purpose, wherein the feed device may further be arranged to move the positioning sleeve out of the working area towards the ejection opening, and to move the positioning sleeve out of the ejection opening.

Furthermore, it may be preferred that the ejection device comprises a spring arranged and configured to move, in particular to push, the positioning sleeve out of the ejection opening. By means of the spring of the ejection device, the positioning sleeve can be disposed of from the feed device without manual effort.

In a further preferred embodiment of the feed device, it is provided that the guide unit is arranged to move the positioning sleeve from the working area into an ejection area in which the ejection device acts, and preferably this movement is affected with the piston coupled to the positioning sleeve.

The guide unit is preferably tubular, wherein the working area is arranged adjacent to a distal end of the guide unit, the coupling area is arranged adjacent thereto, and the ejection area is provided adjacent to a proximal end of the guide unit. In addition, the ejection region may also be provided between the working region and the coupling region.

A further preferred embodiment of the feed device is characterized in that it comprises a control device arranged to control the movement unit such that the welding filler element and/or the positioning sleeve is moved from the coupling region to the working region, and the welding filler element is moved out at a distal end of the guide unit, preferably relative to a distal end of the positioning sleeve.

It is preferred that the welding filler element is moved out based on a predefined movement pattern. Furthermore, it may be preferred that the welding filler element is moved out based on a closed-loop control, in particular a closed-loop control. The control device is preferably set up to determine a feed rate for the welding filler element based on recorded process data. The feed speed of the welding filler element is in particular the speed at which the welding filler element emerges at the distal end of the guide unit and/or the positioning sleeve.

In a further preferred embodiment of the guide unit, it is provided that the guide unit has a shielding gas nozzle coupled to a further shielding gas supply, which is set up to supply a shielding gas to a deposition welding processes. In particular, it is preferred that the shielding gas nozzle is arranged in an area adjacent to the distal end of the guide unit.

According to a further aspect, the aforementioned task is solved by a positioning sleeve for a feed device, in particular for a feed device according to one of the embodiments described in the foregoing, for feeding welding filler elements for a deposition welding process, preferably for a laser deposition welding process, which is designed to receive a welding filler element, in particular a wire-shaped and/or rod-shaped welding filler element, and extends from a distal end to a proximal end, comprising a sleeve cavity extending from the distal end to the proximal end, for the arrangement of the welding filler element, the distal end being designed such that the welding filler element can be moved out.

Adjacent to the distal end of the positioning sleeve, the latter preferably has a conical geometry. In particular, it is preferred that an outer diameter of the positioning sleeve tapers or reduces in a portion adjacent the distal end towards the distal end. It is further preferred that the cavity has a substantially constant diameter from the distal end toward the proximal end. In addition, it may be preferred that the diameter of the sleeve cavity tapers towards the distal end.

In a preferred embodiment of the positioning sleeve, the positioning sleeve is provided with a coupling portion adjacent the proximal end for coupling the positioning sleeve to a coupling member, the coupling portion having a groove and/or a collar or being a groove and/or a collar.

Further preferably, the coupling portion of the positioning sleeve may comprise or be made of a magnetic material to enable magnetic coupling with the coupling element.

A further preferred embodiment of the positioning sleeve is characterized in that a welding filler element, in particular a wire-shaped and/or rod-shaped welding filler element, is arranged in the sleeve cavity, wherein the sleeve cavity and the welding filler element are arranged such that in the radial direction of the sleeve cavity there is a clearance fit between an inner circumferential surface of the positioning sleeve and an outer circumferential surface of the welding filler element.

According to a further aspect, the aforementioned task is solved by a processing unit, in particular a handling unit, a milling machine and/or for deposition welding, preferably for laser deposition welding, comprising a feed device according to one of the embodiments described in the foregoing. The handling unit can be, for example, a robot, in particular an articulated arm robot, a gantry and/or a portal. Furthermore, other machine tools are also possible as processing unit, preferably a grinding machine and/or a lathe.

According to a further aspect, the aforementioned task is solved by a method for deposition welding, in particular for wire-based laser deposition welding, preferably for wire-based laser deposition welding, comprising the steps: Feeding a welding filler element, in particular a wire-shaped and/or rod-shaped welding filler element, from a receiving unit to a guide unit, providing the welding filler element for deposition welding, and deposition welding with the welding filler element. The deposition welding is in particular a laser deposition welding, preferably a wire-based laser deposition welding, wherein an energy source used is a laser.

A preferred embodiment of the method is characterized in that the deposition welding is performed in a vacuum. In particular, a generated molten pool is in a vacuum. It is further preferred that the deposition welding is an electron beam welding, wherein further preferably the providing is performed by a mechanical action on the welding filler element.

In a preferred further embodiment of the method, it is provided that the welding filler element is disposed in a positioning sleeve, the method comprising the steps of: Feeding the positioning sleeve from the receiving unit to the guide unit, moving the positioning sleeve from a coupling area to a working area, moving the welding filler element relative to the positioning sleeve, in particular moving the welding filler element out of a distal end of the positioning sleeve, and preferably moving the positioning sleeve to an ejection area and disposing the positioning sleeve.

The method and its possible embodiments have features or method steps, respectively, that make them particularly suitable to be used for a feeding device described in the foregoing and/or a positioning sleeve and its embodiments.

For further advantages, embodiment variants and embodiment details of the further aspects and their possible further embodiments, reference is also made to the previously given description regarding the corresponding features and further embodiments of the feeding device.

Preferred embodiments are explained by way of example with reference to the accompanying figures: They show:

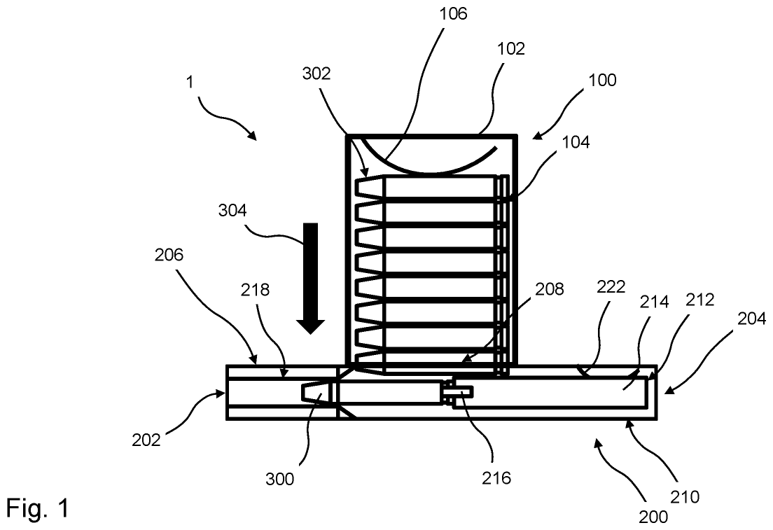

FIG. 1: a schematic, two-dimensional view of an exemplary embodiment of a feeding device;

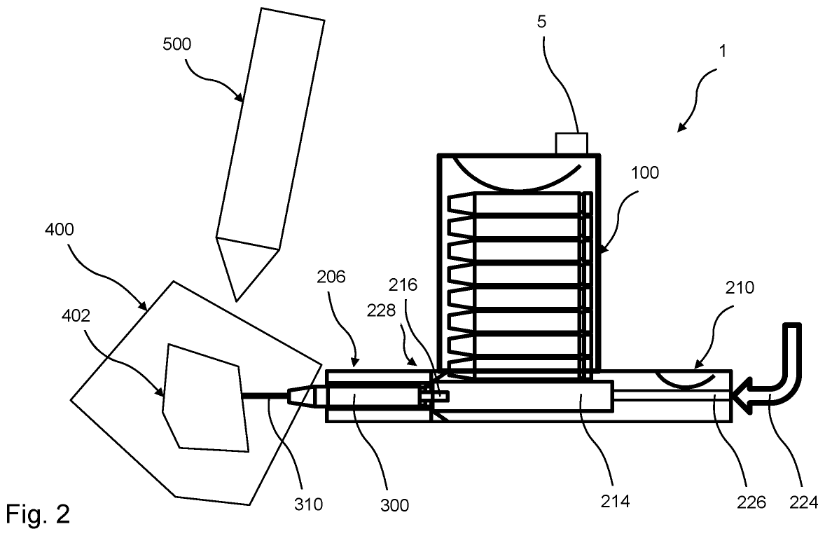

FIG. 2: a schematic, two-dimensional view of the feeding device shown in FIG. 1 in operation for processing a workpiece;

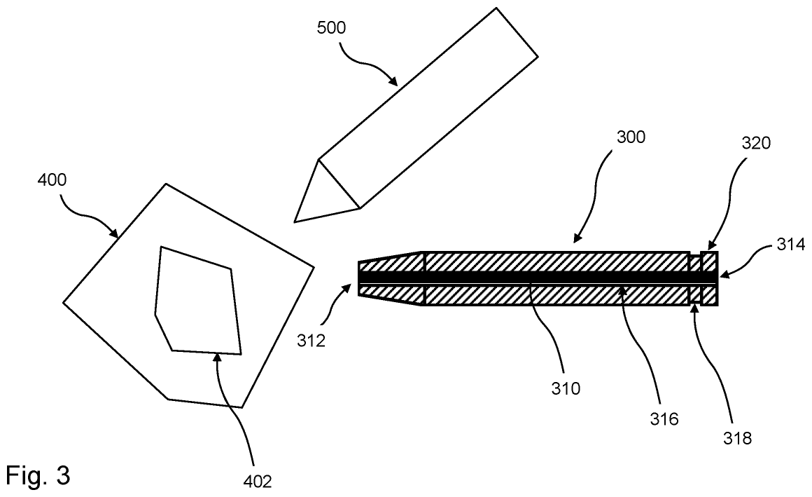

FIG. 3: a schematic, two-dimensional detailed view of a positioning sleeve in operation for machining a workpiece;

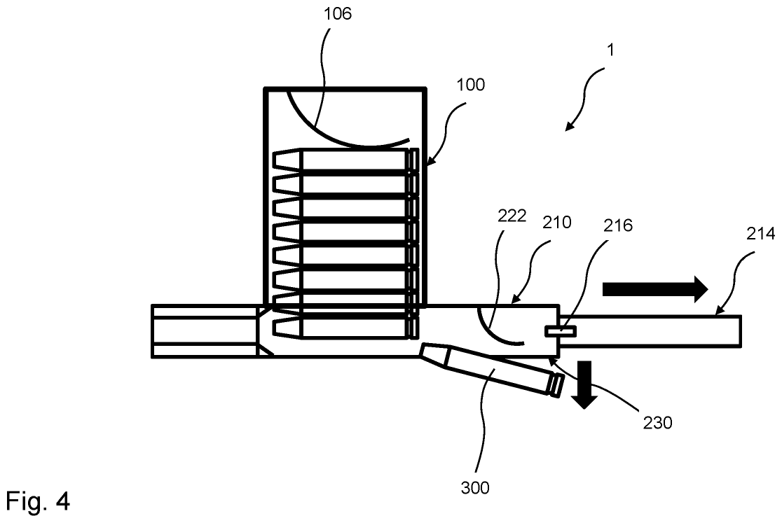

FIG. 4: another schematic, two-dimensional view of the feeding device shown in FIG. 1;

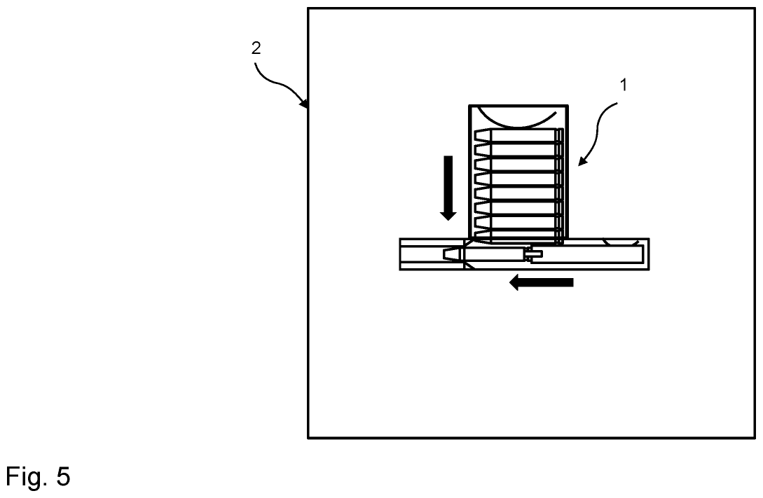

FIG. 5: a schematic view of a machining unit with a feeding device;

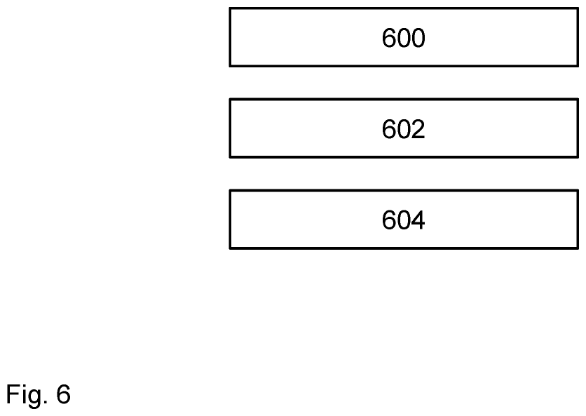

FIG. 6: a schematic view of an exemplary process; and

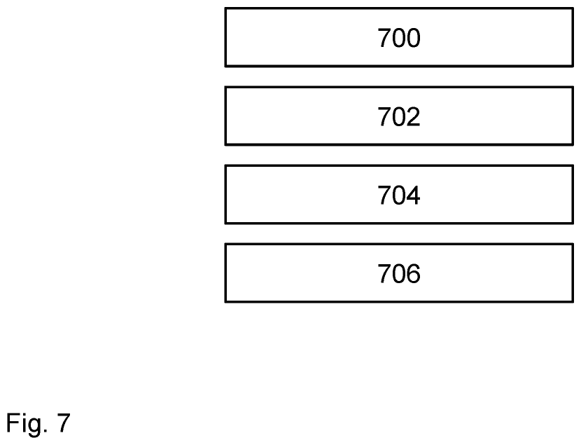

FIG. 7: a schematic view of an embodiment of the process shown in FIG. 6.

In the figures, identical or substantially functionally identical or similar elements are designated by the same reference signs.

The feeding device 1 shown in FIG. 1 comprises a receiving unit 100 for receiving a plurality of positioning sleeves 302 with welding filler elements 310 and a guide unit 200 arranged and adapted to feed a welding filler element 310 arranged in one of the positioning sleeves 300, 302 to a deposition welding processes.

The receiving unit 100 includes a housing 102, and a holding device 104 is provided within the housing 102 to receive the plurality of positioning sleeves 302. In addition, the receiving unit 100 includes a spring 106 that applies vertically directed downward pressure to the positioning sleeves 302. The housing 102 of the receiving unit 100 includes an opening at a vertically lower portion thereof. Through this opening, the positioning sleeves 300, 302 can pass to the guide unit 200. The area in which the positioning sleeves 300, 302 pass from the receiving unit 100 to the guide unit 200 is referred to as the coupling area 208. The positioning sleeves 300, 302 are provided with the positioning sleeve feed direction 304 of the guide unit 200.

The guide unit 200 has a tubular geometry extending from a first end 202 to a second end 204. The first end 202 of the guide unit 200 may also be referred to as a distal end, and the second end 204 may be referred to as a proximal end. The guide unit 200 is tubular in shape, and thus in particular has a cavity extending from the first end 202 to the second end 204. The positioning sleeve 300 can move within this cavity. In the coupling region 208, the positioning sleeve 300 is transferred from the receiving unit 100 to the guide unit 200. In the coupling region 208, the positioning sleeve 300 is connected to a piston 214 by means of a coupling element designed as a clamp 216. The piston 214 forms a movement unit 212, which is arranged to move the welding filler element 310 with the positioning sleeve 300 from the coupling region 208, in which the welding filler element 310 and/or the positioning sleeve 300 pass from the receiving unit 100 to the guide unit 200, to the working region 206, in which the welding filler element is positioned such that it can be used for deposition welding processes.

The working area 206 of the guide unit 200 includes a guide channel 218. The guide channel 218 is characterized by having a smaller diameter than the wider cavity of the guide unit 200. This smaller diameter of the guide channel 218 positions the positioning sleeve 300 in a portion adjacent the first end 202, which is the distal end.

In FIG. 2, it is shown that the positioning sleeve 300 is located in the working area 206. For this purpose, the piston 214 has been moved towards a central portion of the guide unit 200. As a result of the piston 214 being coupled to the positioning sleeve 300, the positioning sleeve 300 has been pushed into the guide channel 218. A distal portion of the positioning sleeve 300 is now outside of the guide unit 200. Furthermore, a fluid supply 224 has caused the welding filler element 310 disposed within the positioning sleeve 300 to move out of a distal end of the positioning sleeve 300. This outward movement allowed the welding filler element 310 to be delivered to a molten pool 402 of a component 400. The weld pool 402 on the component 400 was affected by an energy source 500, which is in particular a laser.

The welding filler element 310 is disposed within the positioning sleeve 300 by means of a clearance fit. The plunger 214 has a shielding gas channel that passes through the plunger 214 toward the clamp 216, wherein in the region of the clamp 216 the shielding gas is guided toward the positioning sleeve 300 and there causes a pressure on the welding filler element 310. Due to this pressure caused by the shielding gas, the welding filler element 310 is pressed out of the positioning sleeve 300. Thus, a continuous supply of the welding filler element 310 to the molten pool 402 is enabled. In order for the shielding gas to reach the welding filler element 310 through the shielding gas channel of the piston 214, the feeding device 1 comprises the fluid feed 224. Furthermore, the feed device 1 includes a fluid channel 226 designed, for example, by a hose coupled to a proximal end of the piston 214.

Furthermore, the feeding device 1 comprises a control device 5 arranged to control the movement unit 212 such that the welding filler element 310 and/or the positioning sleeve 300 is moved from the coupling region 208 to the working region 206, and the welding filler element 310 is moved out at a distal end of the guide unit 200, preferably relative to a distal end of the positioning sleeve 300.

In particular, the detailed view in FIG. 3 shows a sectional view of the positioning sleeve 300. The positioning sleeve 300 extends from a distal sleeve end 312, which faces a molten pool 402 in the intended operation, to a proximal sleeve end 314, which faces away from a molten pool 402 in the intended operation. A sleeve cavity 316 extends from the distal sleeve end 312 toward the proximal sleeve end 314.

Within the sleeve cavity 316, the filler metal 310 is disposed. Furthermore, it can be seen that the welding filler element 310 is arranged with a clearance fit in the sleeve cavity 316. This clearance fit is particularly preferred to allow the welding filler element 310 to be moved out of the sleeve cavity 316 with a low pressure to be delivered to the molten pool 402. In a portion adjacent the proximal sleeve end 314, the positioning sleeve 300 includes a collar 320 designed by a groove 318. The groove 318 is engageable by the clamp 216. The clip 216 holds the positioning sleeve 300 in position in the work area 206.

In FIG. 4, a dispose the positioning sleeve 300 is shown. By means of the piston 214, the positioning sleeve 300 is moved from the working area 206 through the coupling area 208 to an ejection area 210. The ejection device disposed in the ejection region 210 includes a spring 222. The spring 222 pushes the positioning sleeve 300 in the ejection area 210 through an ejection opening 230 out of the feed device 1 or out of the guide unit 200. For this purpose, the guide unit 200 is designed such that the piston 214 can emerge at least in sections at the second end 204.

FIG. 5 schematically shows a processing unit 2, in particular a milling machine and/or for laser deposition welding. The processing unit 2 comprises a feed device 1 as described in particular in the preceding.

FIG. 6 shows a schematic process. In step 600, a welding filler element 310, in particular a wire-shaped and/or rod-shaped and/or straight welding filler element 310, is fed from a receiving unit 100 to a guide unit 200. In step 602, the welding filler element 310 is provided for deposition welding on a component 400. In step 604, the filler metal 310 is used for buildup welding.

FIG. 7 shows another schematic process. In step 700, a positioning sleeve 300 with a welding filler element 310 is transferred from the receiving unit 100 to the guide unit 200. In step 702, the positioning sleeve 300 is moved from a coupling region 208 to a working region 206. In step 704, the welding filler element 310 is moved relative to the positioning sleeve 300, in particular relative to a distal end of the positioning sleeve 300. In step 706, the positioning sleeve is moved to an ejection region 210 to dispose the positioning sleeve 300.

The feeding device 1 described in the foregoing has the advantage of efficiently feeding straight welding filler elements 310 to a deposition welding processes on a component 400 having a molten pool 402. Thus, the feeding device 1 overcomes the disadvantage in the prior art that the welding filler elements 310 have a curvature because they are previously wound on a spool. Furthermore, the feeding device 1 overcomes the disadvantage existing in the prior art that straight welding filler elements 310 have to be fed manually, and in a labor-intensive manner, to a deposition welding processes. Thus, the feeding device 1 and in particular a processing unit 2 with the feeding device 1 enables an efficient deposition welding processes and, moreover, improves the quality of the component 400 to be manufactured, since the process stability is increased.

### REFERENCE LIST

1 feeding device

2 processing unit

5 control unit

100 receiving unit

102 housing

104 holding device

106 spring

200 guide unit

202 first end

204 second end

206 working area

208 coupling area

210 ejection area

212 motion unit

214 piston

216 clamp

218 guide channel

222 spring

224 fluid supply

226 fluid channel

228 distal end

230 ejection port

300 positioning sleeve

302 positioning sleeves

304 positioning sleeve feed direction

310 welding filler element

312 distal sleeve end

314 proximal sleeve end

316 sleeve cavity

318 groove

320 collar

400 component

402 melt pool

500 energy source

1. A feeding device (1) for feeding welding filler elements (310), in particular a wire-shaped and/or rod-shaped welding filler element (310), for a deposition welding process, comprising:
a receiving unit (100) for receiving at least one welding filler element (310),
a guide unit (200) arranged and configured to feed the welding filler element (310) to a deposition welding process,
wherein the receiving unit (100) and the guide unit (200) are arranged and configured such that the welding filler element (310) is provided discontinuously to the guide unit (200).

2. The feeding device (1) according to claim 1, further comprising:
at least one positioning sleeve (300, 302),
wherein the at least one welding filler element (310) is coupled to the positioning sleeve (300, 302) and the positioning sleeve (300, 302) is receivable in the receiving unit (100),
wherein the receiving unit (100) and the guide unit (200) are arranged and configured such that the positioning sleeve (300, 302) is provided discontinuously to the guide unit (200), and
wherein preferably the positioning sleeve (300, 302) has a sleeve cavity (316) for arranging and/or passing through the welding filler element (310).

3. The feeding device (1) according to claim 1, wherein
the receiving unit (100) is arranged to receive two or more positioning sleeves (300, 302) each with a welding filler element (310), and
preferably the two or more positioning sleeves (300, 302) can be arranged circumferentially, in particular in a first direction, next to one another in the receiving unit (100), and/or
preferably the two or more positioning sleeves (300, 302) can be arranged circumferentially next to one another in a second direction aligned essentially orthogonally to the first direction.

4. The feeding device (1) according to claim 1, wherein
the guide unit (200) comprises a positioning section configured to position the positioning sleeve (300, 302) and/or the welding filler element (310) such that a distal end of the welding filler element (310) can be fed to a melt pool, and
preferably the positioning section comprises a guide channel (218) having an inner diameter corresponding to the outer diameter of the welding filler element (310) and/or the positioning sleeve (300, 302).

5. The feeding device (1) according to claim 1, comprising a moving unit (212) which is arranged to move the welding filler element (310) and/or the positioning sleeve (300, 302) from a coupling area (208), in which the welding filler element (310) and/or the positioning sleeve (300, 302) passes from the receiving unit (100) to the guide unit (200), to a working area (206) in which the welding filler element (310) is positioned such that it can be used for deposition welding processes.

6. The feeding device (1) according to claim 1, wherein
the moving unit (212) comprises a piston (214), and
the piston (214) is couplable to a proximal end of the welding filler element (310) and/or the positioning sleeve (300, 302).

7. The feeding device (1) according to claim 1, wherein
the guide unit (200) is arranged to move the welding filler element (310) relative to the positioning sleeve (300, 302), and
preferably a fluid, in particular a shielding gas, is supplied such that the welding filler element (310) is moved, in particular continuously, preferably pressed, out of the positioning sleeve (300, 302), and/or
preferably comprises a pressing unit, which is arranged and designed to move the welding filler element out of the distal end of the guide unit and/or the positioning sleeve, in particular continuously, preferably to press it out.

8. The feeding device (1) according to claim 1, wherein
the moving unit (212) comprises a fluid supply (224) arranged and configured to supply a fluid to the proximal end of the welding filler element (310) and/or the positioning sleeve (300, 302) such that the welding filler element (310) is moved out of the distal end of the guide unit (200) and/or the positioning sleeve (300, 302), in particular continuously, preferably pressed out, and
preferably the piston (214) comprises a fluid channel (226), the first piston end of which is coupled to the fluid supply (224) and the second piston end of which is coupled to the positioning sleeve (300, 302), wherein the second piston end can be brought into fluidic contact with the welding filler element (310).

9. The feeding device (1) according to claim 1, comprising:
an ejection device (222) for the positioning sleeve (300, 302), which is arranged to dispose the positioning sleeve (300, 302) from the guide unit (200) and/or the feeding device (1),
wherein preferably the guide unit (200) comprises an ejection opening (230), and/or
wherein preferably the ejection device comprises a spring (222) arranged and configured to move, in particular to push, the positioning sleeve (300, 302) out of the ejection opening (230).

10. The feeding device (1) according to claim 1, wherein
the guide unit (200) is arranged to move the positioning sleeve (300, 302) from the working area (206) into an ejection area (210) in which the ejection device (222) acts, and
preferably this movement is affected with the piston (214) coupled to the positioning sleeve (300, 302).

11. The feeding device (1) according to claim 1, comprising a control device (5) arranged to control the moving unit (212) such that
the welding filler element (310) and/or the positioning sleeve (300, 302) is moved from the coupling area (208) to the working area (206), and
the welding filler element (310) is moved out at a distal end of the guide unit (200), preferably relative to a distal end of the positioning sleeve (300, 302).

12. A positioning sleeve (300, 302) for the feed device (1) according to claim 1, for feeding welding filler elements (310) for a deposition welding processes, which is arranged to receive a welding filler element (310), in particular a wire-shaped and/or rod-shaped welding filler element (310), and extends from a distal end (312) to a proximal end (314), comprising
a sleeve cavity (316) extending from the distal end (312) to the proximal end (314) for arranging the welding filler element (310), wherein the distal end (312) is configured such that the welding filler element (310) can be moved out.

13. The positioning sleeve (300, 302) according to claim 12, comprising
a coupling portion adjacent the proximal end (314) for coupling the positioning sleeve (300, 302) to a coupling member, the coupling portion having a groove (318) and/or a collar (320).

14. The positioning sleeve (300, 302) according to claim 12, wherein a welding filler element (310), in particular a wire-shaped and/or rod-shaped welding filler element (310), is arranged in the sleeve cavity (316), wherein the sleeve cavity (316) and the welding filler element (310) are arranged such that in the radial direction of the sleeve cavity (316) there is a clearance fit between an inner circumferential surface of the positioning sleeve (300, 302) and an outer circumferential surface of the welding filler element (310).

15. A processing unit (2), in particular handling unit and/or milling machine and/or for deposition welding, comprising the feeding device (1) according to claim 1.

16. A method for deposition welding, in particular wire-based deposition welding, comprising the steps of:
feeding a welding filler element (310), in particular a wire-shaped and/or rod-shaped welding filler element (310), from a receiving unit (100) to a guide unit (200);
providing the welding filler element (310) for deposition welding; and
deposition welding with the welding filler element (310).

17. The method according to claim 16, wherein the welding filler element (310) is arranged in a positioning sleeve (300, 302), the method comprising the steps of:
feeding the positioning sleeve (300, 302) from the receiving unit (100) to the guide unit (200);
moving the positioning sleeve (300, 302) from a coupling area (208) to a working area (206);
moving the welding filler element (310) relative to the positioning sleeve (300, 302), in particular moving the welding filler element (310) out of a distal end of the positioning sleeve (300, 302), and
preferably moving the positioning sleeve (300, 302) to an ejection region (210) and disposing the positioning sleeve (300, 302).
